(19) United States
(12) Patent Application Publication
(10) Pub. No.: US 2024/0054555 A1
(43) Pub. Date: Feb. 15, 2024

(54) TERMINAL DEVICE, PRODUCT PROVISION MANAGEMENT PROGRAM, PRODUCT PROVISION MANAGEMENT SYSTEM, AND PRODUCT PROVISION MANAGEMENT METHOD

(71) Applicant: Panasonic Intellectual Property Management Co., Ltd., Kadoma-shi, Osaka (JP)

(72) Inventors: Hiroyoshi OHMIYA, Kadoma-shi, Osaka (JP); Takuro ITO, Kadoma-shi, Osaka (JP)

(21) Appl. No.: 18/550,596

(22) PCT Filed: Jun. 25, 2021
(86) PCT No.: PCT/JP2021/024101

§ 371 Date: Sep. 14, 2023

(30) Foreign Application Priority Data
Apr. 9, 2021 (JP) 2021-066772

(51) Int. Cl. G06Q 30/0645

(52) U.S. Cl. CPC G06Q 30/0645

(57) ABSTRACT

Provided is a product provision management system that makes it easier for a user, who is receiving a subscription service including periodic provision of a product, to select a product equivalent to a charged amount of money for a contract period. The product provision management system in the present disclosure is provided with a terminal device, and a product provision management server for managing the subscription service that combines leasing or rental of a home electric appliance and the periodic provision of the product, the product provision management server including a determination unit for determining whether or not it is possible for the user to be additionally provided with a product within a predetermined period of time based on authentication information and a communication unit for transmitting, to the terminal device owned by the user, image information for causing a providable product display screen to be displayed based on the determination.

### TECHNICAL FIELD

The present disclosure relates to a terminal device, a product provision management program, a product provision management system, and a product provision management method that make it easier for a user, who is receiving a subscription service including periodic provision of a product, to select the product equivalent to a charged amount of money.

### BACKGROUND ART

Conventionally, there has been known a product provision management system that improves user satisfaction in a service that provides a product by way of periodic purchase or subscription (for example, Japanese Patent Laid-Open Publication No. 2020-194363). This product provision management system is configured by using an information processing device, and is provided with an inquiry transmission unit being connected to a user device, which is an information processing device on a user side, in a communicable manner so as to transmit, to the user device, an inquiry message about a provision desired product, which is a product desired to be provided on a next scheduled provision date, a response reception unit for receiving a response message including provision desired product information, which is information indicating the provision desired product and being sent from the user device in response to the inquiry message, and a shipping processing unit for processing information on shipping of the product to the user based on the provision desired product information.

### CITATION LIST

### Patent Literature

[Patent Literature 1] Japanese Patent Laid-Open Publication No. 2020-194363

### SUMMARY OF THE INVENTION

### Technical Problem

In the case of a subscription contract, if the user is allowed to choose whether or not to receive product provision, for example, it is conceivable that the next contract period, which is automatically renewed, may be entered while the user has not received the product equivalent to the charged amount of money for the contract period. The present disclosure provides a terminal device, a product provision management program, a product provision management system, and a product provision management method that make it easier for the user, who is receiving the subscription service including periodic provision of a product, to select the product equivalent to the charged amount of money for the contract period.

### Solution to Problem

The terminal device in the present disclosure is a terminal device owned by a user who is receiving a subscription service that combines leasing or rental of a home electric appliance and periodic provision of a product, which is provided with a terminal input unit to which authentication information of the user is input, and a display unit configured to display a screen transition selection area for transitioning to a providable product display screen, which is a screen for displaying information of the product that can be provided if it is possible for the user to receive provision of the product within a range of the subscription service at a timing at which the authentication information is input.

The product provision management program in the present disclosure is a product provision management program executable by a terminal device, in which the terminal device is caused to function as the terminal device described above.

The product provision management system in the present disclosure is a product provision management system that is provided with the terminal device described above, and a product provision management server for managing a subscription service that combines leasing or rental of a home electric appliance and periodic provision of a product, in which the product provision management server is provided with a determination unit for determining whether or not it is possible for a user to be additionally provided with a product within a predetermined period of time based on authentication information, and a communication unit for transmitting, to the terminal device owned by the user, image information that causes the providable product display screen to be displayed based on the determination.

The product provision management method in the present disclosure is a product provision management method in a terminal device owned by a user who is receiving a subscription service that combines leasing or rental of a home electric appliance and periodic provision of a product, which includes a terminal input step of inputting authentication information of the user, and a display step of displaying a screen transition selection area for transitioning to a providable product display screen, which is a screen for displaying information of the product that can be provided, if it is possible for the user to receive provision of the product within a range of the subscription service at a timing at which the authentication information is input.

Note that the present description includes all the contents of Japanese Patent Application No. 2021-066772 filed on Apr. 9, 2021.

### Advantageous Effect of Invention

The terminal device, the product provision management program, the product provision management system, and the product provision management method in the present disclosure can make it easier for the user, who is receiving the subscription service including the periodic provision of the product, to select the product equivalent to the charged amount of money. Therefore, an excellent effect of improving customer satisfaction is obtained.

### BRIEF DESCRIPTION OF DRAWINGS

FIG. 1 is an explanatory view of the product provision management system.

FIG. 2 is a functional configuration diagram of the terminal device and the product provision management server.

FIG. 3 is a flowchart of the operation of the product provision management server.

FIG. 4 is an explanatory view of a first screen displayed on the display unit of the terminal device.

FIG. 5 is an explanatory view of the providable product display screen.

FIG. 6 is an explanatory view of a first payment screen.

FIG. 7 is a flowchart of the operation of the product provision management server.

FIG. 8 is an explanatory view of a second screen displayed on the display unit of the terminal device.

### DESCRIPTION OF EMBODIMENTS

### Knowledge and the Like that are the Basis of the Present Disclosure

At the time when the inventors came up with the present disclosure, the inventors discovered the problem that a user of a subscription service may forget to receive provision of the service, and in order to solve the problem, the subject matter of the present disclosure came to be composed.

Therefore, the present disclosure provides a terminal device, a product provision management program, a product provision management system, and a product provision management method that make it easier for the user who is receiving the subscription service, which includes periodic provision of a product, to select the product equivalent to a charged amount of money.

Hereinafter, the embodiments will be described in detail with reference to the drawings. However, a description too detailed to be necessary may be omitted. For example, a detailed description of an already well-known matter or a duplicate description for the substantially same configuration may be omitted. This is to prevent the following description from becoming unnecessarily redundant and to facilitate the understanding of those skilled in the art.

It should be noted that the accompanying drawings and the following description are provided for those skilled in the art to fully understand the present disclosure, and are not intended to limit the subject matter described in the claims.

### Embodiment 1

### 1-1. Configuration

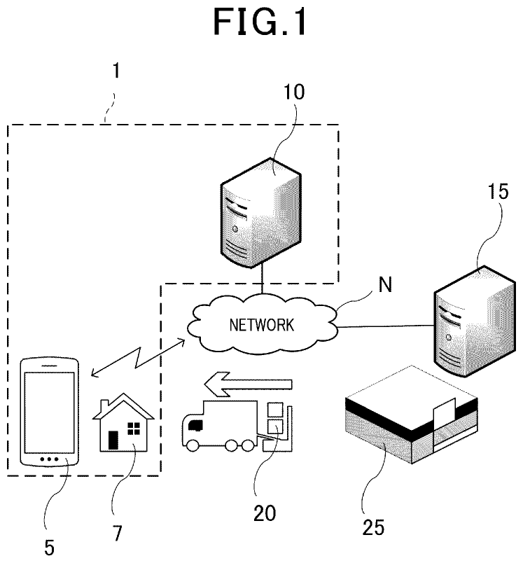

FIG. 1 is an explanatory view of a product provision management system 1 according to an embodiment 1 of the present disclosure. The product provision management system 1 includes a terminal device 5 owned by a user 7 and a product provision management server 10. Here, the terminal device 5 is a terminal device owned by the user 7 who is receiving a subscription service that combines leasing or rental of a home electric appliance and periodic provision of a product 20, and is provided with a terminal communication unit 8 to which authentication information of the user 7 is input, and a display unit 27 configured to display a first screen transition selection area 35, which is a screen transition selection area for transitioning to a providable product display screen 40 to be described later, which is a screen for displaying information of the product 20 that can be provided if it is possible for the user 7 to receive provision of the product 20 within a range of the subscription service at a timing at which the authentication information is input.

The providable product display screen 40 includes a product selection area 45, which will be described later, in which it is possible to select at least one product 20 that can be provided.

The product provision management server 10 is the product provision management server 10 for managing the subscription service that combines leasing or rental of a home electric appliance and periodic provision of the product 20, and includes a determination unit 22 for determining whether or not it is possible for the user 7 to be additionally provided with the product 20 within a predetermined period of time based on the authentication information, and a communication unit 21 for transmitting, to the terminal device 5 owned by the user 7, image information that causes the providable product display screen 40 to be displayed based on the determination.

In the present description, the subscription service means a business in which the user can use a product or a service for a predetermined period of time by paying a usage fee, and includes, for example, a service in which the user pays a monthly usage fee to a product provider, thereby the product equivalent to a fixed monthly amount of money is periodically provided. Further, the above-mentioned subscription service that combines leasing or rental of a home electric appliance and the periodic provision of the product 20 can specifically include a subscription service that combines leasing or rental of a washing machine and periodic provision of a detergent exclusively for the washing machine, combines a dishwasher and periodic provision of a detergent exclusively for the dishwasher, combines an air purifier and periodic provision of a filter, and combines a cooking home electric appliance, such as an oven range, a heated steam oven range, or a hot cooker, or a refrigerator and periodic provision of a cooking ingredient.

Specifically, in the subscription service in the present description, when the user intents to receive the service, the user selects a service that is desired to be used from a plurality of candidate services as described below, for example.

(Candidate Service 1)

Leasing of a home electric appliance A (a microwave oven) and provision of a set of 5 pieces (frozen food) once a month . . . 4,450 yen/month

(Candidate Service 2)

Leasing of the home electric appliance A (the microwave oven) and provision of a set of 7 pieces (frozen food) once a month . . . 5,340 yen/month

(Candidate Service 3)

Leasing of a home electric appliance B (a rice cooker) and provision of a set of 6 pieces (rice) once a month . . . 4,450 yen/month

The user selects the subscription service that is desired to be used from the above candidate services 1 to 3. Then, once a month, the user can receive provision of the product corresponding to the selected service. At this time, the user can also select a desired product from the plurality of candidates.

In the subscription service described above, the user needs to select a product to be provided every month. Instead, there is an advantage that the product to be provided every month can be changed to a desired product. Specifically, if a new product is added, a change can be made so as to receive the new product. In addition, there is an advantage that the user himself or herself can decide provision timing. Specifically, for example, it is possible to receive product provision for the current month at a timing at which the product provided in the previous month is about to be used up.

Further, in the present description, the authentication information of the user is the information to identify the user, and may include, for example, a name of the user, a password determined by the user, a card number of a credit card used by the user, information of the subscription service used by the user, and the like.

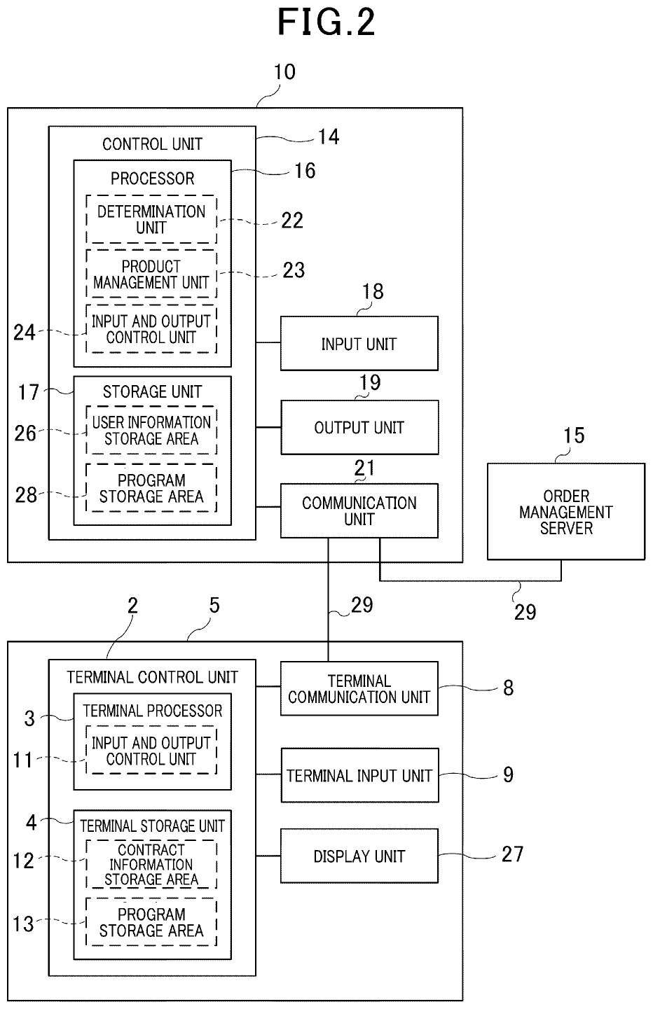

FIG. 2 is a functional configuration diagram of the terminal device 5 and the product provision management server 10. The terminal device 5 is an information terminal owned by the user 7, and is provided with a terminal control unit 2 for controlling the terminal, a terminal communication unit 8 for transmitting and receiving information to and from the outside, a terminal input unit 9 for inputting information, and a display unit 27 for outputting and displaying image information and the like. The terminal control unit 2 includes a terminal storage unit 4 for storing information, and a terminal processor 3 for executing a program stored in a program storage area 13 of the terminal storage unit 4 to realize various functions. The terminal processor 3 realizes, for example, a function of an input and output control unit 11 for controlling image display on the display unit 27. The terminal storage unit 4 includes a contract information storage area 12 for storing a contract period, a contract content, and the like concluded by the user 7 with the product provider, and a program storage area 13 for storing the program for realizing the various functions.

Here, the terminal device 5 may be a mobile information terminal, specifically, a smartphone. Further, the terminal device 5 may be a PC (personal computer) or a tablet PC. The terminal input unit 9 of the terminal device 5 may be an image display device provided as the display unit 27 of the terminal device 5, specifically, a touch panel arranged on the surface of a liquid crystal panel, an organic EL panel, or the like. In the case of the PC, a keyboard, a mouse, or the like may of course be used as the terminal input unit 9. Selection of a first screen transition selection area 35, a product selection area 45, a provision decision selection area 55, a second screen transition selection area 65, and a product selection area 75, which will be described later, may be executed by touching, with a finger, an area of the touch panel corresponding to the relevant area.

Further, the product provision management server 10 may be an information processing device such as a computer. Specifically, the product provision management server 10 is provided with a control unit 14 for controlling the entire server, a communication unit 21 for transmitting and receiving information to and from the outside, an input unit 18 for inputting information, and an output unit 19 for outputting image information and the like. The control unit 14 includes a storage unit 17 for storing information, and a processor 16 for executing a program stored in a program storage area 28 of the storage unit 17 to realize various functions. The processor 16 realizes functions of a product management unit 23 for managing, for example, information of product provision related to the subscription service, an input and output control unit 24 for controlling input and output, a determination unit 22 that will be described later, and the like. The storage unit 17 includes a user information storage area 26 for storing information of the user such as the authentication information input by the user 7, and a program storage area 28 for storing the program for realizing various functions.

The terminal control unit 2 of the terminal device 5 and the control unit 14 of the product provision management server 10 include the terminal processor 3 and a processor 16, respectively. Specifically, as the processor, a CPU (Central Processing Unit), an MPU (Micro-Processing Unit), or the like can be considered, for example. As a storage medium of the terminal storage unit 4 and the storage unit 17, a hard disk, a flash memory, an optical disk, or the like can be considered, for example.

The terminal device 5 and the product provision management server 10 are connected to each other via a network N. A connection 29 to the network N may be a wireless connection conforming to a wireless communication standard such as WiFi (registered trademark) or a wired connection. Information input from the terminal device 5 is transmitted to the product provision management server 10 through the network N, and when the product provider provides the product 20 to the user 7 according to the subscription service, communication related to order processing is performed from the product provision management server 10 to an order managements server 15. Then, the product 20 is delivered from a product storage 25 to the user 7. Here, the product storage 25 may also be a place at which the product itself is manufactured. A service provider of the subscription service and the product provider may be the same or different. For example, the service provider may be a person who only plays a role of distributing, to the user, a product menu provided by the product provider and managing order information to the product provider.

### 1-2. Operation of Product Provision Management Server

The operation of the product provision management server 10 included in the product provision management system 1 configured as described above will be described below.

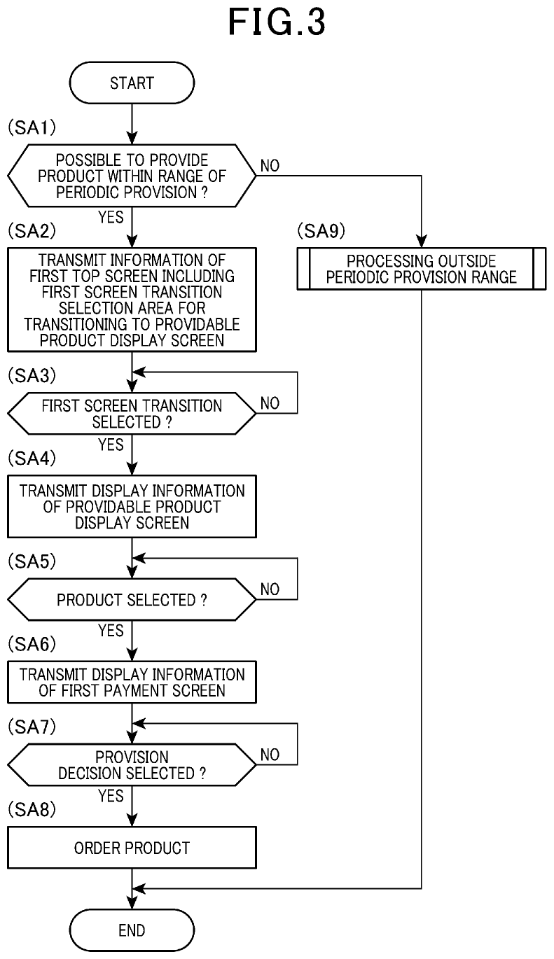

FIG. 3 is a flowchart of the operation of the product provision management server 10. When the authentication information is input from the terminal input unit 9 of the terminal device 5 of the user 7, the determination unit 22 of the product provision management server 10 determines whether or not it is possible to provide the product 20 to the user 7 within a range of the periodic provision if the user 7 is entitled based on the authentication information (step SA1). The range of the periodic provision means, for example, a predetermined limited amount of a cooking ingredient that can be provided for the monthly usage fee. If it is not possible to provide the product within the range of the periodic provision (step SA1: NO), for example, if the user 7 has already received the provision of the predetermined amount of a cooking ingredient within a period of time predetermined in the subscription service, processing outside the periodic provision range, which will be described later, is performed (step SA9). When the determination unit 22 determines that it is possible to provide the product 20 to the user 7 within the range of the periodic provision (step SA1: YES), the product provision management server 10 transmits, to the terminal device 5, information of a first screen 30 including the first screen transition selection area 35, which is the screen transition selection area for transitioning to the providable product display screen 40 (step SA2). Of course, a mechanism, in which the program storage area 13 of the terminal device 5 has been given the information of the first screen 30 in advance and the first screen 30 is displayed with a signal from the product provision management server 10, may also be used.

Now, if the product provision management server 10 receives information that first screen transition has been selected in the terminal input unit 9 of the terminal device 5 (step SA3: YES), the product provision management server 10 transmits, to the terminal device 5, display information of the providable product display screen 40 (step SA4). If it is not selected whether or not to perform a screen transition in the product provision management server 10 (step SA3: NO), the product provision management server 10 waits until the selection is made. If no information is input from the terminal device 5 for a certain period of time or more, the process may be terminated.

If a product is selected on the providable product display screen 40 including the product selection area 45 in which it is possible to select at least the one product 20 that can be provided to the user 7 (step SA5: YES), the product provision management server 10 transmits, to the terminal device 5, display information of a first payment screen 50 (step SA6). If none of the products 20 is selected (step SA5: NO), the product provision management server 10 waits until a product is selected. If no information is input from the terminal device 5 for a certain period of time or more, the process may be terminated.

If a provision decision is selected on the first payment screen 50 displayed on the display unit 27 of the terminal device 5, specifically, if a provision decision selection area 55A to be described later is selected (step SA7: YES), order information for ordering the product 20 is transmitted from the product provision management server 10 to the order management server 15 and the order for the product 20 is completed (step SA8). If no selection is made in the provision decision selection area 55 (step SA7: NO), the product provision management server 10 waits until a selection is made. If no information is input from the terminal device 5 for a certain period of time or more, the process may be terminated.

To summarize the above, the product provision management system 1 according to the present embodiment is provided with the product provision management server 10 for managing the subscription service that combines, for example, leasing or rental of a home electric appliance and the periodic provision of the product 20, the product provision management server 10 including the determination unit 22 for determining whether or not it is possible for the user 7 to be additionally provided with the product 20 within a predetermined period of time based on the authentication information and the communication unit 21 for transmitting, to the terminal device 5 owned by the user 7, image information that causes the providable product display screen 40 to be displayed based on the determination, and the terminal device 5 owned by the user.

Note if the contract period for providing the service starts from the first day of each month and ends on the last day of the month, and the condition is that the service is automatically continued unless the user cancels the contract, for example, it is conceivable to send, from the product provision management server 10 to the terminal device 5, an e-mail or the like for prompting the product selection if the product has not been provided yet one week before the last day of the month. It is also conceivable, of course, to display a sales promotion screen for prompting the product selection on the display unit 27 according to a program stored in the program storage area 13 based on information stored in the contract information storage area 12 of the terminal storage unit 4.

### 1-3. Display Screens

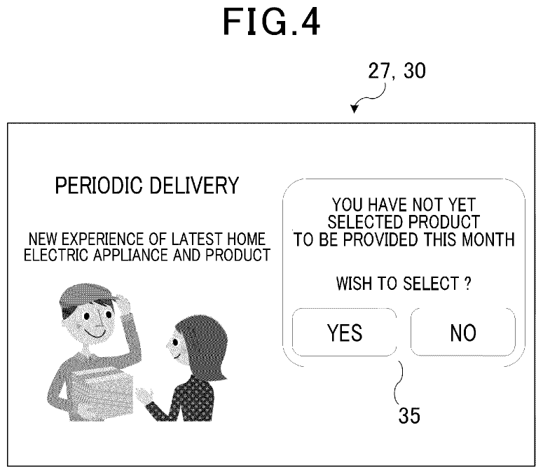

In FIGS. 4 to 6, examples of display screens will be described, which are displayed on the display unit 27 of the terminal device 5 included in the product provision management system 1 according to the embodiment 1. Note that in FIGS. 4 to 6 described below, the display screens premised on a subscription service for a combination of a cooking home electric appliance or a refrigerator and periodic provision of a cooking ingredient are given as the examples, but they are not intended to limit the subject matter described in the claims.

FIG. 4 is an explanatory view of the first screen 30 displayed on the display unit 27 of the terminal device 5. The first screen 30 is a screen transmitted to the terminal device 5 of the user 7, who is entitled to be provided with a product at the time of access based on the authentication information input by the user 7 when the access occurs from the terminal device 5 owned by the user 7 to the product provision management server 10, and displayed on the display unit 27.

Specifically, the first screen 30 includes the first screen transition selection area 35 for transitioning to the providable product display screen 40, which is a screen for displaying information of the product 20 that can be provided if it is possible for the user 7 to receive the product provision within the range of the subscription service at a timing at which the authentication information is input.

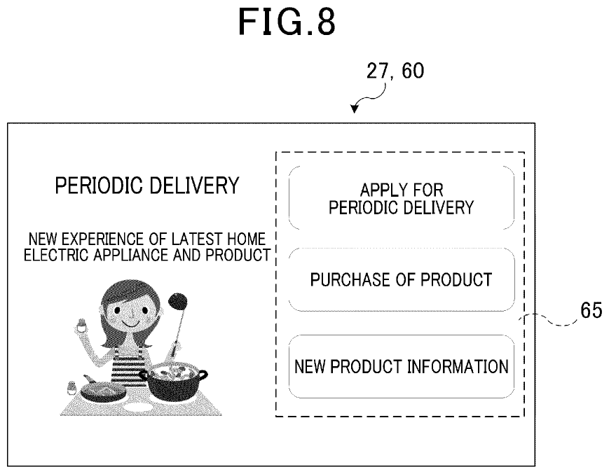

In the first screen transition selection area 35 shown in FIG. 4, for example, if the user 7 selects “No”, information of a newly providable service or product, for example, may be displayed (see FIG. 8 to be described later).

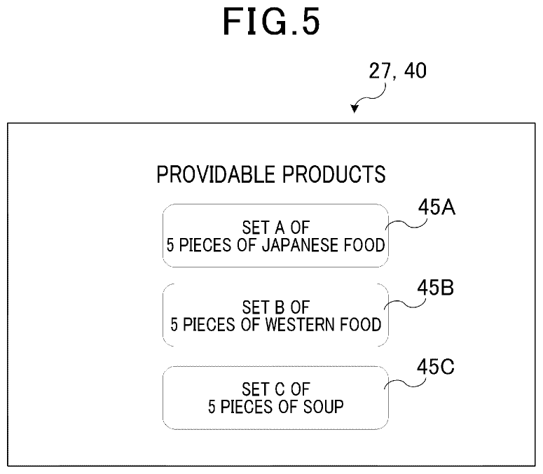

FIG. 5 is an explanatory view of the providable product display screen 40 displayed on the display unit 27 when the user 7 determines to select a product in the first screen transition selection area 35 of FIG. 4 and the user 7 inputs that determination from the terminal input unit 9.

The providable product display screen 40 includes the product selection area 45 in which it is possible to select at least one product that can be provided. FIG. 5 shows that three products, “a set A of five pieces of Japanese food”, “a set B of five pieces of Western food”, and “a set C of five pieces of soup”, can be provided. For example, if the user 7 selects a product selection area 45A, “the set A of five pieces of Japanese food” is provided by the product provider within the range of the periodic provision.

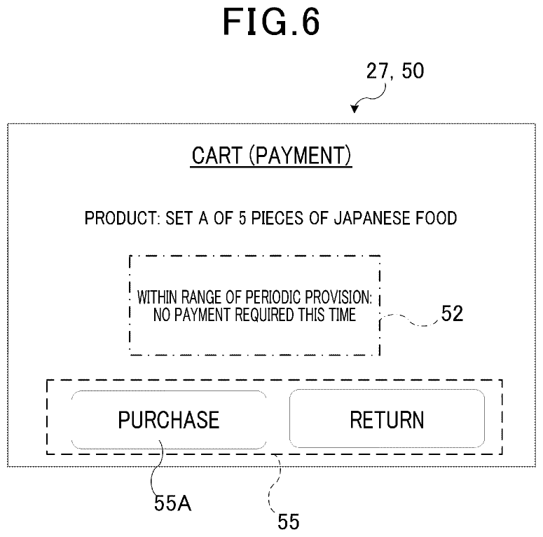

FIG. 6 is the first payment screen 50 displayed on the display unit 27 when the product selection area 45A is selected in the product selection area 45 of the providable product display screen 40. Here, information 52 is provided to notify the user 7 that no additional payment will be incurred because the selection is within the range of the periodic provision based on the subscription service. The first payment screen 50 may include the provision decision selection area 55 for selecting provision of the product so that the user 7 can input whether or not to receive the provision of the product.

Further, as a modified embodiment, when the user 7 needs to pay a shipping fee separately, the first payment screen 50 may display the fact that the shipping fee needs to be paid.

### 1-4. Operation of Processing Outside Periodic Provision Range

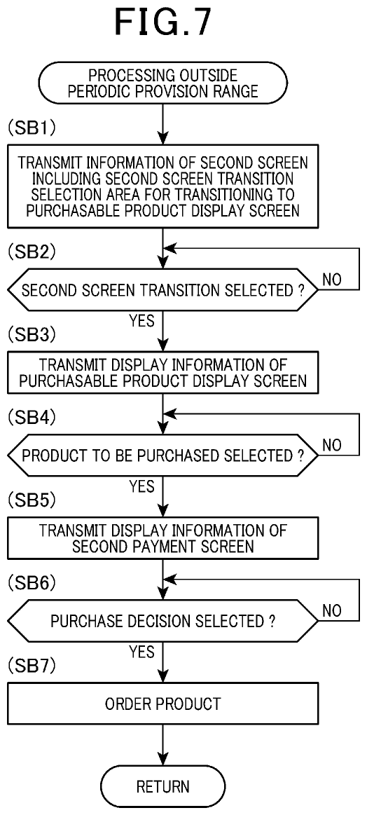

FIG. 7 is a flowchart of the operation of the product provision management server 10. Specifically, in FIGS. 7 to 8, the processing outside the periodic provision range will be described, which corresponds to step SA9 in the flowchart of FIG. 3 described above. In other words, processing will be described when it is not possible to provide a product within the range of the periodic provision (step SA1 of FIG. 3: NO), for example, when the predetermined amount of a cooking ingredient has already been received within the period of time prescribed in the subscription service.

If the determination unit 22 of the product provision management server 10 determines that it is not possible to provide the product 20 to the user 7 within the range of the periodic provision (step SB1: NO), the product provision management server 10 transmits, to the terminal device 5, information of a second screen 60 including a second screen transition selection area 65, which is a screen transition selection area for transitioning to a purchasable product display screen or the like (step SB1). Of course, a mechanism, in which the program storage area 13 of the terminal device 5 has been given the information of the second screen 60 in advance and the second screen 60 is displayed with a signal from the product provision management server 10, may also be used.

Now, if the product provision management server 10 receives information that purchase of a product has been selected in the terminal input unit 9 of the terminal device 5 (step SB2: YES), the product provision management server 10 transmits, to the terminal device 5, display information of the purchasable product display screen (step SB3). If it is not selected whether or not to perform a screen transition in the product provision management server 10 (step SB2: NO), the product provision management server 10 waits until the selection is made. If no information is input from the terminal device 5 for a certain period of time or more, the process may be terminated.

If a product is selected on the purchasable product display screen including the product selection area in which it is possible to select at least the one product 20 that the user 7 can purchase (step SB4: YES), the product provision management server 10 transmits, to the terminal device 5, display information of a second payment screen (step SB6). If none of the products 20 is selected (step SB4: NO), the product provision management server 10 waits until a product is selected. If no information is input from the terminal device 5 for a certain period of time or more, the process may be terminated.

If a purchase decision is selected on the second payment screen displayed on the display unit 27 of the terminal device 5, specifically, if a purchase is selected in a purchase decision selection area (step SB6: YES), order information for ordering the product 20 is transmitted from the product provision management server 10 to the order management server 15 and the order for the product 20 is completed (step SB7). If it is not selected whether or not to make a purchase (step SB6: NO), the product provision management server 10 waits until a selection is made. If no information is input from the terminal device 5 for a certain period of time or more, the process may be terminated.

### 1-5. Display Screen for Processing Outside Periodic Provision Range

In FIG. 8, an example of a display screen will be described, which is displayed on the display unit 27 of the terminal device 5 in the processing outside the periodic provision range shown in FIG. 7. Note that in FIG. 8 described below, the display screen premised on a subscription service for a combination of a cooking home electric appliance or a refrigerator and periodic provision of a cooking ingredient is given as the example, but it is not intended to limit the subject matter described in the claims.

FIG. 8 is an explanatory view of the second screen 60 displayed on the display unit 27 of the terminal device 5. The second screen 60 is a screen transmitted to the terminal device 5 owned by the user 7, who is not entitled to purchase a product within the range of the periodic provision at the time of access when the access occurs from the terminal device 5 owned by the user 7 to the product provision management server 10 but can purchase a product outside the range of the periodic provision, and displayed on the display unit 27. At this time, the user 7 may be authenticated based on the authentication information.

Specifically, the second screen 60 may be provided with a second screen transition selection area 65 to another screen for applying for a periodic delivery, purchasing a product, be notified of a new product, and the like.

As described above, in the above-described embodiment, the information is provided to the user 7 with visually recognizable images, but the information may be provided by a voice. In that case, the display unit 27 may be provided with a speaker for generating the voice. For inputting, a microphone may be provided as the terminal input unit 9.

### 1-6. Effect and the Like

As described above, in the present embodiment, the product provision management system 1 is provided with the terminal device 5, and the product provision management server 10 for managing the subscription service that combines leasing or rental of a home electric appliance and the periodic provision of the product 20, the product provision management server 10 including the determination unit 22 for determining whether or not it is possible for the user 7 to be additionally provided with the product 20 within the predetermined period of time based on the authentication information, and the communication unit 21 for transmitting, to the terminal device 5 owned by the user, the image information for causing the providable product display screen 40 to be displayed based on the determination.

As a result, the user is less likely to lose an opportunity when it is possible for the user to receive the periodic provision of the product. Therefore, the effect of improving customer satisfaction is obtained.

### Embodiment 2

### 2-1. Configuration

A terminal device according to an embodiment 2 of the present disclosure is a terminal device 5 owned by a user who is receiving a subscription service that combines leasing or rental of a home electric appliance and periodic provision of a product, which is provided with a terminal input unit to which authentication information of the user is input, and a display unit configured to display a first screen transition selection area, which is a screen transition selection area for transitioning to a providable product display screen that is a screen for displaying information of a product that can be provided if it is possible for the user to receive provision of the product within the range of the subscription service at a timing at which the authentication information is input.

Further, in the terminal device according to the embodiment 2, the providable product display screen described above includes a product selection area in which it is possible to select at least the one product that can be provided.

Since the physical configuration and the basic operation of the terminal device according to the embodiment 2 of the present disclosure are the same as those of the terminal device 5 included in the product provision management system 1 according to the embodiment 1 described above, the description thereof will be omitted (see FIGS. 2, 3, 7 and the like).

### 2-2. Display Screens of Terminal Device, and the Like

Since the display screens displayed by the display unit of the terminal device according to the embodiment 2 of the present disclosure are the same as the display screens displayed by the display unit 27 of the terminal device 5 included in the product provision management system 1 according to the embodiment 1 described above, the description thereof will be omitted (see FIGS. 4 to 6, FIG. 8, and the like).

### 2-3. Effect and the Like

With the terminal device 5 according to the embodiment 2, the user is less likely to lose an opportunity when it is possible for the user to receive the periodic provision of the product. Therefore, the effect of improving customer satisfaction is obtained.

### Embodiment 3

### 3-1. Configuration

A product provision management program according to an embodiment 3 of the present disclosure is a product provision management program executable by a terminal device, in which the terminal device is caused to function as a terminal device owned by a user who is receiving a subscription service that combines leasing or rental of a home electric appliance and periodic provision of a product, the terminal device being provided with a terminal input unit to which authentication information of the user is input and a display unit configured to display a first screen transition selection area, which is a screen transition selection area for transitioning to a providable product display screen that is a screen for displaying information of the product that can be provided if it is possible for the user 7 to receive provision of the product within a range of the subscription service at a timing at which authentication information is input.

Further, the product provision management program according to the embodiment 3 causes the terminal device to function such that the providable product display screen displayed on the display unit of the terminal device includes a product selection area in which it is possible select at least the one product that can be provided.

Since the physical configuration and the basic operation of the terminal device realized by the product provision management program according to the embodiment 3 of the present disclosure are the same as those of the terminal device 5 included in the product provision management system 1 according to the embodiment 1 described above, the description thereof will be omitted (see FIGS. 2, 3, 7, and the like).

### 3-2. Display Screens of Terminal Device and the Like

Since the display screens displayed by the display unit of the terminal device realized by the product provision management program according to the embodiment 3 of the present disclosure are the same as those of the display screens displayed by the display unit 27 of the terminal device 5 included in the product provision management system 1 according to the embodiment 1 described above, the description thereof will be omitted (see FIGS. 4 to 6, FIG. 8, and the like).

### 3-3. Effect and the Like

With the product provision management program according to the embodiment 3, the user is less likely to lose an opportunity when it is possible for the user to receive the periodic provision of the product. Therefore, the effect of improving customer satisfaction is obtained.

### Embodiment 4

### 4-1. Configuration

A product provision management method according to an embodiment 4 of the present disclosure is a product provision management method in a terminal device owned by a user who is receiving a subscription service that combines leasing or rental of a home electric appliance and periodic provision of a product, which is provided with a terminal input step of inputting authentication information of the user and a display step of displaying a screen transition selection area for transitioning to a providable product display screen, which is a screen for displaying information of the product that can be provided if it is possible for the user to receive provision of the product within a range of the subscription service at a timing at which the authentication information is input.

Further, in the present embodiment, the product provision management method includes a determination step of determining whether or not it is possible for the user to be additionally provided with a product within a predetermined period of time based on the authentication information and a transmission step of transmitting, to the terminal device owned by the user, image information for causing the providable product display screen to be displayed based on the determination.

### 4-2. Display Screens and the Like

Since the display screens displayed on the display unit of the terminal device in the display step of the product provision management method according to the embodiment 4 of the present disclosure are the same as the display screens displayed by the display unit 27 of the terminal device 5 included in the product provision management system 1 according to the embodiment 1 described above, the description thereof will be omitted (see FIGS. 4 to 6, FIG. 8, and the like).

### 4-3. Effect and the Like

With the product provision management method according to the embodiment 4, the user is less likely to lose an opportunity when it is possible for the user to receive the periodic provision of the product. Therefore, the effect of improving customer satisfaction is obtained.

With the product provision management method according to the embodiment 4, the user can confirm on the terminal device what product can be selected within the range of the periodic provision in the form of a list. Therefore, the effect of improving customer satisfaction is obtained.

As described above, the embodiments 1, 2, 3, and 4 have been described as examples of the technique disclosed in the present application. However, the technique in the present disclosure is not limited to this, and can be applied to embodiments in which changes, replacements, additions, omissions, or the like have been made. It is also possible to combine the components described in the embodiments 1, 2, 3, and 4 to form a new embodiment.

For example, step units of the processing operations shown in FIGS. 3 and 7 are obtained by dividing the operations according to the main processing contents in order to make it easier to understand the operation of the product provision management server 10 included in the product provision management system 1. Therefore, the present invention is not limited by the method of division or the name of a processing unit. Division into more step units depending on the processing content is also possible. Further, one step unit may be divided so as to include more processes. Further, the order of the steps may be appropriately replaced as long as interference with the gist of the present invention is not caused.

### INDUSTRIAL APPLICABILITY

The present disclosure is applicable to a product provision management program, a product provision management system, a product provision management method, and a terminal device in general included in the product provision management system, all of which manage periodic product provision.

### REFERENCE SIGNS LIST

1 Product provision management system 1
2 Terminal control unit 2
3 Terminal processor 3
4 Terminal storage unit 4
5 Terminal device 5
7 User 7
8 Terminal communication unit 8
9 Terminal input unit 9
10 Product provision management server 10
11 Input and output control unit 11
12 Contract information storage area 12
13 Program storage area 13
14 Control unit 14
15 Order management server 15
16 Processor 16
17 Storage unit 17
18 Input unit 18
19 Output unit 19
20 Product 20
21 Communication unit 21
22 Determination unit 22
23 Product management unit 23
24 Input and output control unit 24
25 Product storage 25
26 User information storage area 26
27 Display unit 27
28 Program storage area 28
29 Connection 29
30 First screen 30
35 First screen transition selection area 35
40 Providable product display screen 40
45 Product selection area 45
50 First payment screen 50
55 Provision decision selection area 55
60 Second screen 60
65 Second screen transition selection area 65
N Network N

1. A terminal device owned by a user who is receiving a subscription service that combines leasing or rental of a home electric appliance and periodic provision of a product, comprising:
a terminal input unit to which authentication information of the user is input; and
a display unit configured to display a screen transition selection area for transitions to a providable product display screen, which is a screen for displaying information of the product that can be provided if it is possible for the user to receive provision of the product within a range of the subscription service at a timing at which the authentication information is input.

2. The terminal device according to claim 1, wherein the providable product display screen includes a product selection area in which it is possible to select at least the one product that can be provided.

3. A non-transitory computer-readable storage medium executable by the terminal device, wherein the terminal device is caused to function as the terminal device according to claim 1.

4. A product provision management system, comprising:
a terminal device according to claim 1; and
a product provision management server for managing a subscription service that combines leasing or rental of a home electric appliance and periodic provision of a product,
wherein the product provision management server is provided with:
a determination unit for determining whether or not it is possible for the user to be additionally provided with a product within a predetermined period of time based on the authentication information; and
a communication unit for transmitting, to the terminal device owned by the user, image information that causes the providable product display screen to be displayed based on the determination.

5. A product provision management method in a terminal device owned by a user who is receiving a subscription service that combines leasing or rental of a home electric appliance and periodic provision of a product, comprising:
an input step of inputting authentication information of the user; and
a display step of displaying a screen transition selection area for transitioning to a providable product display screen, which is a screen for displaying information of the product that can be provided, if it is possible for the user to receive provision of the product within a range of the subscription service at a timing at which the authentication information is input.

6. The product provision management method according to claim 5, comprising:
a determination step of determining whether or not it is possible for the user to be additionally provided with a product within a predetermined period of time based on the authentication information; and
a transmission step of transmitting, to the terminal device owned by the user, image information for causing the providable product display screen to be displayed based on the determination.
